(19) United States
(12) Patent Application Publication
(10) Pub. No.: US 2025/0055104 A1
(43) Pub. Date: Feb. 13, 2025

(54) INSULATOR DEVICE FOR A BATTERY HOUSING, BATTERY HOUSING AND USE OF AN INSULATOR DEVICE IN A BATTERY HOUSING

(71) Applicant: POLYTEC PLASTICS Germany GmbH & Co. KG, Lohne (DE)

(72) Inventors: Walter VAN GILST, Lohne (DE); Jens HUCKLE, Graben-Neudorf (DE); Tobias BURKERT, Lohne (DE); Michael BUCK, Damme (DE); Jorge SOARES, Lohne (DE); Christoph LESON, Lohne (DE); Christian BERDING, Lohne (DE)

(21) Appl. No.: 18/788,799

(22) Filed: Jul. 30, 2024

(30) Foreign Application Priority Data
Aug. 10, 2023 (DE) 10 2023 121 466.7

(51) Int. Cl. H01M 50/233; H01M 50/222; H01M 50/224; H01M 50/227; H01M 50/229; H01M 50/231; H01M 50/367

(52) U.S. Cl. CPC H01M 50/233; H01M 50/222; H01M 50/224; H01M 50/227; H01M 50/229; H01M 50/231; H01M 50/367; H01M 2220/20

(57) ABSTRACT

An insulator device for a battery housing, the battery housing comprising at least one housing wall for enclosing an interior for receiving a battery cell arrangement, the insulator device comprising at least one first insulating layer arranged between the battery cell arrangement and the housing wall in the interior, wherein the at least one first insulating layer is configured for electrical and thermal insulation of the battery cell arrangement.

### CROSS REFERENCE TO RELATED APPLICATION

This application claims priority to German Patent Application No. DE 10 2023 121 466.7, filed Aug. 10, 2023, incorporated herein by reference.

The present invention relates to an insulator device for a battery housing, a battery housing comprising an insulator device according to the invention as well as the use of an insulator device according to the invention in a battery housing of a motor vehicle battery.

Devices for thermal and/or electromagnetic insulation of a vehicle battery arrangement from the environment are already known from prior art.

Battery housings from prior art for traction batteries and drive batteries of electrically powered vehicles, respectively, usually have at least two interconnected battery housing components, which together form a battery housing for enclosing a receiving space for the arrangement of batteries and battery cell arrangements, respectively. Known battery housing components are usually made of metallic materials, mostly aluminum or steel. Said battery housing components and battery housings, respectively, enable effective shielding of the environment of the battery housing component from electromagnetic radiation of the traction battery arranged in the receiving space and also effective shielding of the traction battery from electromagnetic radiation originating from radiation sources in the environment of the traction battery, for example from the electrically powered vehicle itself. Said battery housing components and battery housings made of metallic materials usually have the disadvantage that they are very heavy.

DE 10 2020 111 062 A1 describes the provision of shielding elements in the area of plastic housings for receiving batteries, wherein the shielding elements are provided with an electrically conductive coating for electromagnetic shielding of battery cells received in the receiving space of the battery housing. The disadvantage of said shielding elements is that they are attached to the outside of the battery housing and are exposed to both environmental influences and the effects of the environment due to stone chipping, etc.

Based on the aforementioned disadvantages of the prior art, the present invention is based on the object of providing an improved insulator device for a battery housing and an improved battery housing for the thermal and/or electromagnetic insulation of a vehicle battery and a battery cell arrangement, respectively.

According to a first aspect, the object is achieved by an insulator device for a battery housing, wherein the battery housing comprises at least one housing wall for completely or at least partially enclosing an interior for receiving a battery cell arrangement in the interior.

The insulator device according to the invention comprises at least one first insulating layer arranged between the battery cell arrangement and the housing wall of the battery housing in the interior, wherein the at least one first insulating layer is configured for electrical and thermal insulation of the battery cell arrangement. The arrangement of the at least one first insulating layer in the interior of the battery housing protects it from external influences, which can significantly reduce the risk of damage. Furthermore, the insulator device according to the invention can achieve a dual function by initially insulating and shielding, respectively, the actual battery housing both thermally and electrically from the received batteries.

The insulator device can be formed substantially along an extension plane that extends between the housing wall of the battery housing and a battery cell arrangement received in the battery housing. The extension plane can preferably extend planar and flat, but according to the invention it can also be curved and arched, respectively.

Preferably, the dimensions of at least one insulating layer orthogonal to an extension plane can be formed smaller than the dimensions of the at least one first insulating layer in the extension plane. The design of the insulator device as a thin insulating layer has the advantage that the insulator device can be inserted as a layer between the battery cell housing and the battery cell arrangement and existing interspaces can be used reasonably without significantly increasing the overall dimensions of the battery housing.

For example, the dimensions of the first insulating layer orthogonal to the extension plane are smaller by at least a factor of 20 than the largest dimension seen in the extension plane of the first insulating layer.

In an exemplary embodiment, the first insulating layer can have dimensions of 1000 mm×2000 mm in the plane of the extension plane and a dimension or thickness of 15 mm orthogonal to the aforementioned extension plane.

The at least one first insulating layer can be substantially planar, in particular plate-shaped, and have a first surface facing the battery cell arrangement and a second surface facing away from the battery cell arrangement.

The dimensions of the at least one first insulating layer orthogonal to an extension plane of the insulating layer can be at least 1 mm.

Preferably, it may be provided that the least one first insulating layer is detachably formed with the battery cell arrangement and/or the battery housing.

For example, a detachable connection can be latching elements adapted to one another, which are formed between the at least one first insulating layer and the opposite battery housing and a part of a battery cell arrangement to be connected, respectively. For example, a hook-loop connection can be provided to establish a separable connection.

According to the invention, however, it may also be provided to detachably connect the at least one insulating layer to the battery housing and the battery cell arrangement, respectively, using screws, rivets or other commercially available fastening means. The provided embodiment of the detachable connection initially ensures that the insulator device according to the invention is fixed in relation to the other parts of the battery housing and the battery cell arrangement during use in operation, respectively, but in the event of subsequent recycling, for example at the end of the service life of a battery, it enables the battery housing and the battery cell arrangement to be disassembled, wherein the insulator device according to the invention can be separated from the other parts in a pure and residue-free manner.

In an alternative embodiment, it can also be provided to inseparably connect the insulator device to the battery housing and/or the battery cell arrangement; such a connection can be made, for example, by bonding or thermally joining or welding the insulator device according to the invention, preferably the at least one first insulating layer, to the battery housing and/or parts of the battery cell arrangement.

The at least one first insulating layer can be made of a thermoset material, in particular a fiber-reinforced and/or glass fiber-reinforced material. Providing a thermoset material makes it possible to guarantee a stability of the at least one insulating layer even at increased temperatures, for example during thermal runaway of a battery cell arrangement.

The thermoset embodiment can thus ensure that the insulating layer and the insulator device, respectively, remains stable at the desired arrangement location over a longer period of time, even under thermal stress, and does not deform or bend significantly under the thermal loads that occur. The insulating layer according to the invention can thus shield the escaping fluids and particles of the battery cell arrangement from the actual battery cell housing, at least in partial areas.

According to the invention, it may be provided that the at least one first insulating layer comprises a sheet molding compound (SMC) material.

The material of the material forming the at least one first insulating layer, in particular the SMC material, can additionally comprise an additive, in particular a flame retardant, preferably aluminum trihydrate (ATH).

According to the invention, the at least one first insulating layer can comprise a plurality of protruding elements on its first surface facing the battery cell arrangement.

The elevations and/or rip-shaped protrusions can preferably be formed for dividing an interspace between the battery cell arrangement and the first surface into several interspace sections and/or for forming venting channels. In the event of thermal runaway of a battery cell of the battery cell arrangement to be received, the venting channels allow the fluids and particles of the venting event escaping from the cell to be discharged along the venting channel along a defined path. In particular, the fluids and particles can be guided to at least one safety valve of the battery cell housing. Providing the venting channels and/or interspace sections also limits the spread of fluids and particles to a local area of the battery housing in the event of thermal runaway of a single cell, thus preventing or at least reducing thermal runaway of further individual battery cells. The configuration of the rib-shaped protrusions has the additional advantage that the bending stiffness of the first insulating layer can be increased around its extension plane without having to increase the thickness of the insulating layer in the entire extension area. The above-mentioned measure can increase the bending stiffness without simultaneously resulting in a significant increase in weight.

The protruding elements can preferably be formed opposite a cell support structure of the battery cell arrangement to be received in order to introduce forces that occur, for example due to deformations occurring in the area of the housing wall, directly into the cell support structure. The arrangement of the protruding elements, preferably the rib arrangement, can be selected such that forces introduced into the battery housing and the housing wall of the battery housing from below, e.g. by the vehicle touching down or objects impacting underneath the vehicle, can be introduced directly through the ribs and/or protruding elements of the insulating layer into load-bearing structures of the battery cell arrangement. This advantageous embodiment prevents the cells of the received battery cell arrangement and their electrical contacts from being directly damaged when external forces act on the battery housing.

In particular, the rib-shaped protrusions can extend parallel to each other at least in sections and/or the plurality of venting channels can extend substantially parallel to each other. It can preferably be provided that the width of the formed venting channels and thus the dimensions of the venting channels along the extension direction of the at least one first insulating layer is greater than the average height and thus the average dimension orthogonal to the extension plane of the venting channels.

In addition to the at least one first insulating layer, the insulator device can comprise at least one second insulating layer arranged between the first insulating layer and the housing wall in the interior.

The at least one second insulating layer can be substantially planar, in particular plate-shaped, and have a first surface facing the first insulating layer a second surface facing away from the first insulating layer.

The at least one second insulating layer can be configured such that it can be detachably connected to housing wall and/or preferably detachably connected to the first insulating layer.

Corresponding detachable connections can be made in the same way as for the detachable connection of the at least one first insulating layer to the battery housing or the battery cell arrangement. Alternatively, it can be provided according to the invention that the at least one second insulating layer is permanently connected to the at least one first insulating layer and/or at least parts of the battery housing. Such permanent connections can be established, for example, by bonding, welding or similar joining methods.

The at least one first and/or at least one second insulating layer can comprise at least one layer of a composite material, such as in particular a fiber-reinforced composite material and preferably a fiber composite material with a glass fiber content.

The at least one layer of the composite material can comprise quartz glass fibers or silica glass fibers. The quartz glass fibers can have an increased silicon dioxide (SiO₂) content (>90%) compared to E-glass fibers and have an increased heat resistance in the range of over 1,000° C.

The at least one layer formed by a fiber composite material can be a unidirectional (UD) tape fabric, for example. The matrix material of the composite material can be formed particularly advantageously from a plastic that is compatible with the battery housing. This makes it possible to form an at least partial material bond between the battery housing and/or the at least one first insulating layer and/or the at least one second insulating layer during the manufacturing process.

For example, the at least one insulating layer could be formed of a thermoplastic polypropylene tape with a unidirectional glass fiber reinforcement with a glass fiber weight content of 70% (PP-DU-GF70) and the battery housing could be formed of glass fiber-reinforced polypropylene with a glass fiber weight content of 30% (PP-GF30).

To improve the bonding or adhesion of the at least one second insulating layer to the battery housing and/or to the at least one first insulating layer, the at least one second insulating layer can be at least partially provided with a layer of a bonding agent.

The at least one second insulating layer can be configured to shield electromagnetic radiation from the environment from the battery cell arrangement or vice versa.

The at least one second insulating layer can be formed from a foil made of a metal, in particular an aluminum foil. The formed foils can be designed to be perforated throughout or at least partially.

Furthermore, it may be provided that the at least one second insulating layer comprises a foil made of plastic with an electrically conductive, in particular metallic coating, such as a copper and/or nickel coating. An electromagnetic shielding layer can be formed by applying a thin layer of an electrically conductive layer. Compared to providing of the entire layer of electrically conductive material, providing the plastic with the conductive coating reduces the resulting overall weight.

The at least one second insulating layer can comprise a fabric formed of threads, in particular of metallic threads, or a fabric formed of plastic fibers with an electrically conductive coating, in particular a metallic coating, particularly preferred a copper or nickel coating.

As an alternative to providing fabrics, fiber fabrics such as, in particular, nonwovens formed from metallic fibers or plastic fibers with corresponding metallic coatings can also be provided for forming the at least one second insulating layer according to the invention.

The at least one second insulating layer can be formed from fabrics, in particular woven fabrics or nonwovens, with a coating, in particular a metallic coating, preferably with a copper or aluminum or nickel coating.

According to a second aspect of the present invention, a battery housing can be formed which comprises at least one housing wall for at least partially enclosing an interior, wherein the interior is configured to receive a battery cell arrangement and at least one insulator device according to the first aspect of the present invention, wherein the at least one insulator device according to the invention is arranged between the battery cell arrangement and the housing wall in the interior.

By arranging the at least one first insulator device between the battery cell arrangement and the housing wall, the housing wall is at least partially delimited or covered from the battery cell arrangement and in particular the battery cells by means of the insulator device according to the invention, so that gases, fluids and/or particles escaping from the battery cell arrangement, for example, can be shielded from the housing wall of the battery housing or insulated by means of the at least one first insulating layer and particularly preferably can also be discharged into specific areas of the battery housing.

According to the invention, the at least one housing wall of the battery housing can be formed from a thermoplastic resin.

According to a further aspect of the present invention, an insulator device according to the invention can be used in a battery housing of a motor vehicle battery, in particular a motor vehicle battery of electrically powered motor vehicles, such as in particular automobiles, aircraft and/or ships.

In the following, exemplary embodiments of the insulator device according to the invention and of the battery housing are illustrated with reference to the accompanying schematic Figures.

### IN THE FIGURES

FIG. 1 shows a schematic sectional view of a first exemplary embodiment of an insulator device according to the invention in a battery housing;

FIG. 2A shows a schematic sectional view of a second exemplary embodiment of an insulator device according to the invention in a battery housing;

FIG. 2B shows a schematic sectional view of a third exemplary embodiment of an insulator device according to the invention in a battery housing;

FIG. 2C shows a schematic sectional view of a fourth exemplary embodiment of an insulator device according to the invention in a battery housing;

FIG. 3A shows a schematic sectional view of a fifth exemplary embodiment of an insulator device according to the invention in a battery housing when a venting event occurs;

FIG. 3B shows the fourth exemplary embodiment of the insulator device in a battery housing in sectional view when a crash event occurs.

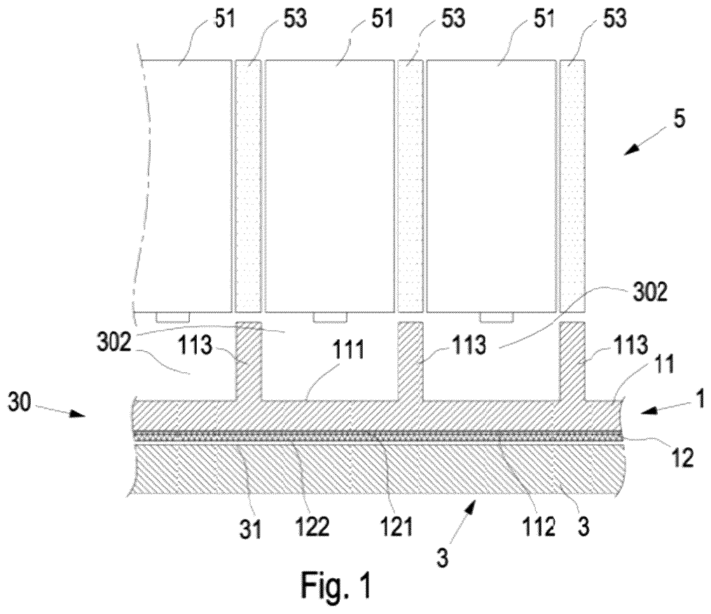

FIG. 1 shows an insulator device 1 in a battery housing 3, wherein battery housing 3 comprises at least one housing wall 31 for enclosing an interior 30. To simplify the illustration, only a partial section of battery housing 3 is shown in FIG. 1. As illustrated, a battery cell arrangement 5 is received in interior 30.

Such a battery cell arrangement 5 can be a combination of several individual battery cells 51, which are combined to form a battery cell arrangement 5, for example via further structural elements such as, in particular, a cell carrier structure 53. Such cell arrangements can include supports or struts for receiving and separating the individual battery cells, for example. By providing battery cell arrangement 5, several individual battery cells 51 can be combined to form a composite, which has a high mechanical stability.

FIG. 1 shows a sectional view of a first insulating layer 11 configured for electrical and thermal insulation of battery cell arrangement 5. The first insulating layer 11 is initially substantially flat and has a first surface 111 facing battery cell arrangement 5 and a second surface 112 facing away from battery cell arrangement 5. The specific exemplary embodiment of the illustrated first insulating layer 11 further comprises on its first surface 111 a plurality of optional protruding elements 113, which are configured to form and divide an interspace between battery cell arrangement 5 and the first surface 111 into several interspace sections and to form several venting channels 302, as illustrated in FIG. 1, respectively.

The illustrated insulator device 1 according to FIG. 1 further comprises a second insulating layer 12 arranged between the first insulating layer 11 and housing wall 31. The at least one second insulating layer 12 can extend substantially parallel to the at least one first insulating layer 11, as shown in FIG. 1. However, according to the invention, different forms of the first and/or second insulating layer 11, 12 relative to the battery housing 3 can also be provided.

The second insulating layer 12 can again be substantially planar, in particular plate-shaped, and have a first surface 121 facing the first insulating layer 11 and a second surface 122 facing away from the first insulating layer 11. Here, the second surface 122 faces housing wall 31.

The at least one second insulating layer 12 can be configured such that it can be detachably connected to housing wall 31 and/or detachably connected to the first insulating layer 11.

The second surface 122 of the at least one first insulating layer can preferably be connected to the first surfacer 121 of the at least one second insulating layer 12 so that the first and second insulating layer 11, 12 form a common object.

The at least one first insulating layer 11 can be configured such that it can be detachably connected with battery housing 3 and/or with battery cell arrangement 5. For example, latching elements (not shown in FIG. 1) can be provided in the region of the first insulating layer 11 or the projections 113, which can be detachably connected to parts of battery cell arrangement 5, in particular to structural parts of battery cell arrangement 5, for separable fixing of insulator device 1 relative to battery cell arrangement 5.

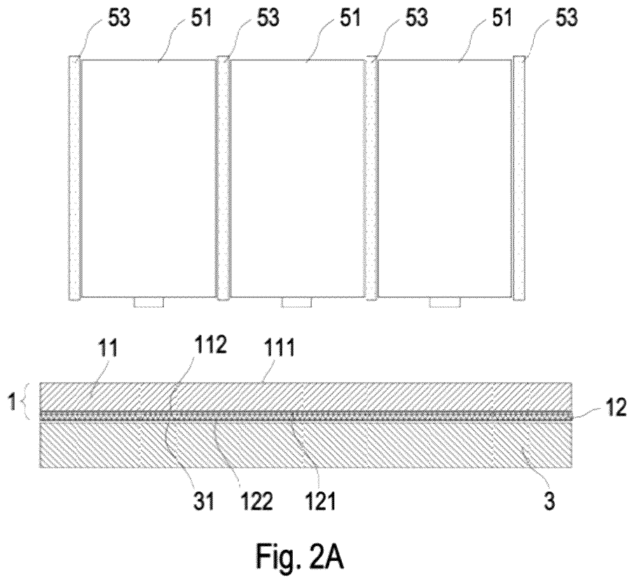

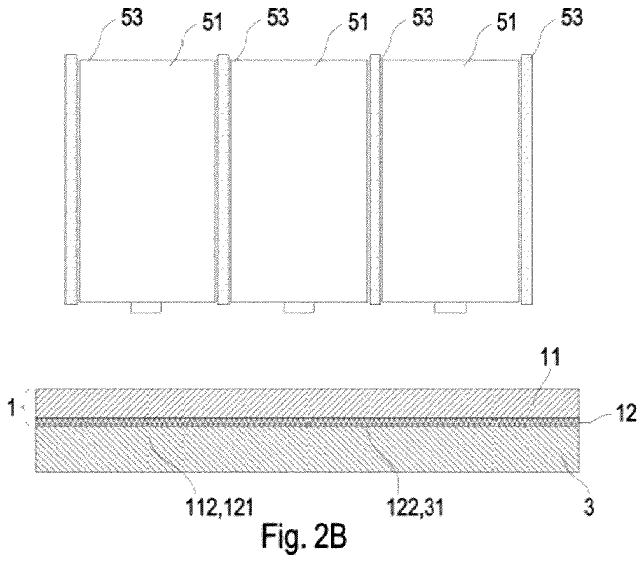

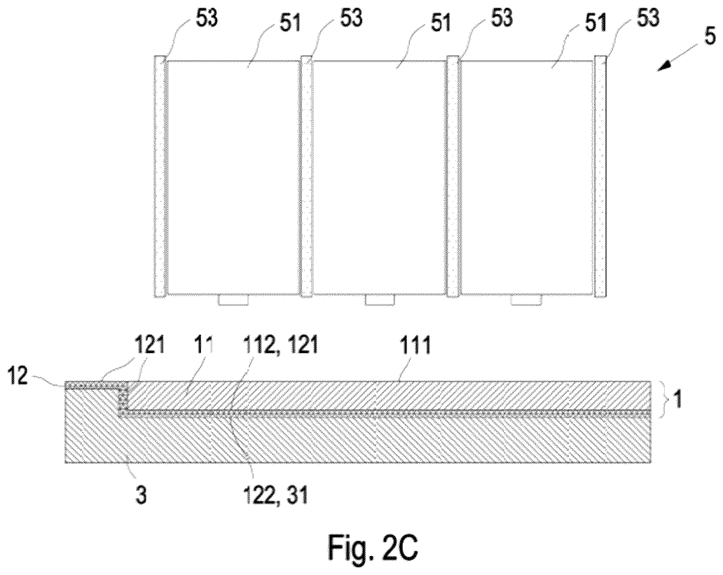

FIG. 2A shows a schematic sectional view of a second exemplary embodiment of an insulator device 1 according to the invention comprising a first insulating layer 11 and a second insulating layer 12. In the illustrated embodiment, the first insulating layer 11 does not have any protruding elements 113, in contrast to the illustrated embodiment in FIG. 1. In the illustrated embodiment according to FIG. 2A, the first insulating layer 11 and the second insulating layer 12 are detachably connected to each other. As can be seen from FIG. 2A, the second surface 112 of the first insulating layer 11 and the first surface 121 of the second insulating layer 12 are directly adjacent to each other for detachable connection and have a small distance to each other, respectively, in which elements for realizing the separable connection between the first and second insulating layers 11, 12 can be arranged, such as a hook-and-eye connection.

Furthermore, according to the embodiment in FIG. 2A, it is provided that the insulator device 1 is detachably connected to housing wall 31 of the battery housing. In this respect, the second surface 122 of the second insulating layer 12 extends at least partially parallel to housing wall 31 and abuts against housing wall 31, respectively, in order to form a detachable connection between the insulator device 1 via the second insulating layer 12 and housing wall 31 precisely in this region. The detachable connection between housing wall 31 and the second insulating layer 12 or between the second insulating layer 12 and the first insulating layer 11 may in particular be a hook-and-eye connection, such as a Velcro-type connection or alternative detachable connection types.

FIG. 2B shows an alternative third embodiment of an insulator device 1 according to the invention, which in turn comprises a first insulating layer 11 and a second insulating layer 12. In contrast to the embodiment shown in FIG. 2A, however, insulator device 1 is inseparably connected to housing wall 31 of battery housing 3, in particular in a force-fit and/or form-fit manner. The insulator device 1 can also be connected to battery housing 3 with a material bond. The second surface 112 of the first insulating layer 11 is formed directly adjacent to the first surface 121 of the second insulating layer 12 and forms a common surface with the latter, respectively. Furthermore, the second surface 122 of the second insulating layer 22 is formed directly adjacent to housing wall 31.

The corresponding force-fit and/or form-fit connections may, for example, involve bonding, in particular, bonding agents may also be used between the at least one first and/or second insulating layer 11, 12 and/or housing wall 31.

FIG. 2C shows a fourth exemplary embodiment of an insulator device 1 according to the invention, wherein the embodiment according to FIG. 2C is initially designed in accordance with the embodiment according to FIG. 2B, wherein a force-fit and form-fit bond is established between the first and second insulating layers 11, 12 and battery wall 31. In contrast to FIG. 2B, the second insulating layer 12 is longer than the first insulating layer 11 in the area of the left end in the plane of the figure, which means that the first insulating layer 11 does not cover the second insulating layer 12 at least in the left partial area in the direction of the illustrated battery cell arrangement 5.

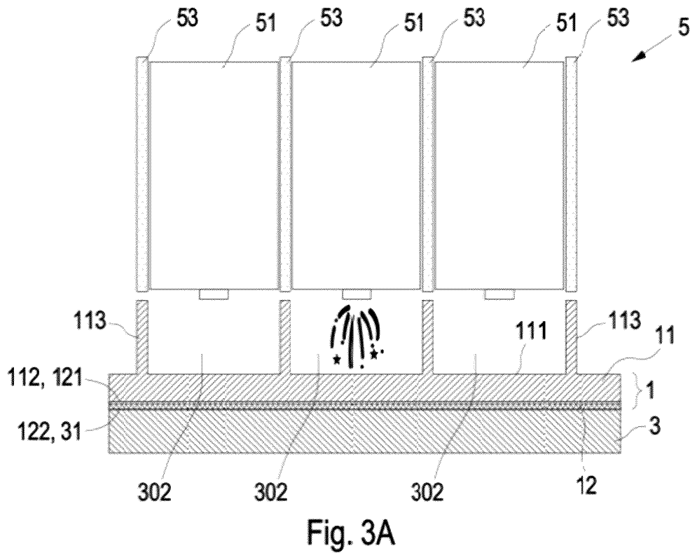

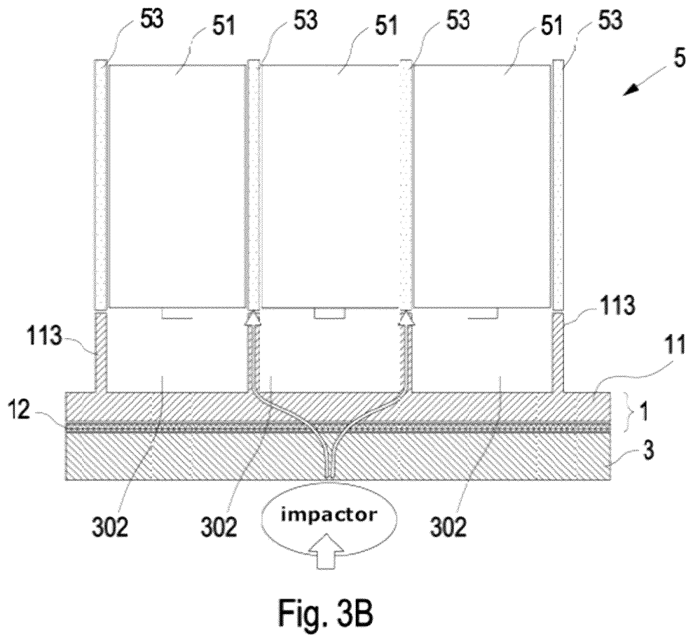

FIGS. 3A and 3B together show a fifth exemplary embodiment of an insulator device 1 according to the invention, which again comprises a first and second insulating layer 11, 12, which are connected to each other, the second insulating layer 12 is again connected to wall 31 of battery housing 3. The first insulating layer 11 has on its first surface 111, which faces battery cell arrangement 5, several elevations 113, which are rib-shaped in the illustrated embodiment. Due to the rib-shaped elevations 113, the interspace between the received battery cell arrangement 5 and the first surface 111 of the first insulating layer is divided into several subregions substantially delimited from one another by the rib-shaped elevations 113, which form three venting channels 302 in the illustrated variant. The cross-sectional profile of the venting channels 302 is shown in the image plane, which have their course in the depth of the image plane of FIGS. 3A and 3B.

If a thermal runaway now occurs in a single battery cell 51 enclosed in battery cell arrangement 5, as schematically illustrated in FIG. 3A, hot venting gases, fluids and also particles escape from a safety valve (not illustrated) of the single battery cell 51 at high speed and high pressure. They now hit the first insulating layer 11 of insulator device 1 and can be guided through the respective venting channel 302 and, for example, to a safety valve of battery housing 3. The arrangement provided prevents the hot venting gases and particles from impinging directly on wall 31 of battery housing 3 and at the same time the escaping gases are channeled in the respective venting channel 302, which can reduce the thermal stress of neighboring individual battery cells 51 of battery cell arrangement 5.

As can be seen in FIGS. 3A and 3B, the elevations 113 of the first insulating layer 11 are formed opposite each other with cell support structures and cell support elements 53 of battery cell arrangement 5, respectively. The elevations 113 are not arranged in the areas of the individual battery cells 51. If, as in FIG. 3B, an object, such as a stone, hits the outer area of battery housing 5, the resulting forces can be transmitted from battery housing 3 via insulator device 1 and in particular via its protruding elements 113 of the first insulating layer 11 directly to the cell support structures 53 and advantageously introduced into them, respectively. Introduction or transmission of the external forces to the individual battery cells 51 can thus be prevented or largely reduced in accordance with the invention.

What is claimed is:

1. An insulator device for a battery housing,
wherein the battery housing comprises at least one housing wall for enclosing an interior to receive a battery cell arrangement, and
the insulator device comprises:
at least one first insulating layer arranged between the battery cell arrangement and the housing wall in the interior,
wherein the at least one first insulating layer is configured for electrical and thermal insulation of the battery cell arrangement.

2. The insulator device according to claim 1, wherein dimensions of at least one insulating layer orthogonal to an extension plane of the first insulating layer are smaller than dimensions of an at least one first insulating layer in the extension plane.

3. The insulator device according to claim 1, wherein at least one first insulating layer is substantially planar and has a first surface facing the battery cell arrangement and a second surface facing away from the battery cell arrangement.

4. The insulator device according to claim 2, wherein the dimensions of the at least one insulating layer orthogonal to the extension plane are at least 1 mm.

5. The insulator device according to claim 1, wherein the at least one first insulating layer is detachably connectable to the battery housing and/or the battery cell arrangement.

6. The insulator device according to claim 1, wherein the at least one first insulating layer comprises a fiber-reinforced thermoset material and/or glass fiber-reinforced thermoset material.

7. The insulator device according to claim 6, wherein the at least one first insulating layer comprises a sheet molding compound (SMC) material.

8. The insulator device according to claim 7, wherein the SMC material comprises a flame retardant material.

9. The insulator device according to claim 1, wherein the at least one first insulating layer comprises a plurality of protruding elements on a first surface of the first insulating layer, the protruding elements comprising elevations and/or rib-shaped protrusions.

10. The insulator device according to claim 9, wherein the elevations and/or rib-shaped protrusions are formed for dividing an interspace between the battery cell arrangement and the first surface into a plurality of interspace sections and/or for forming venting channels.

11. The insulator device according to claim 10, wherein the rib-shaped protrusions extend at least in sections parallel to one another and/or the plurality of venting channels extend substantially parallel to one another, wherein preferably the width of the formed venting channels is greater than the average height of the venting channels.

12. The insulator device according to claim 1, wherein the insulator device further comprises at least one second insulating layer arranged between the first insulating layer and the housing wall in the interior.

13. The insulator device according to claim 1, wherein the insulator device further comprises at least one second insulating layer arranged between the first insulating layer and the housing wall in the interior.

14. The insulator device according to claim 13, wherein the at least one second insulating layer is substantially planar and has a first surface facing the first insulating layer and a second surface facing away from the first insulating layer.

15. The insulator device according to claim 13, wherein the at least one second insulating layer is detachably connectable to the housing wall and/or to the first insulating layer.

16. The insulator device according to claim 14, wherein the second surface of the at least one first insulating layer is connected to the first surface of the at least one second insulating layer.

17. The insulator device according to claim 13, wherein the at least one second insulating layer comprises a foil made of metal.

18. The insulator device according to claim 13, wherein the at least one second insulating layer comprises a foil made of plastic with a metallic coating.

19. The insulator device according to claim 13, wherein the at least one second insulating layer comprises a fabric formed of threads or plastic fibers.

20. The insulator device according to claim 13, wherein the at least one second insulating layer comprises a woven or nonwoven cloth having a metallic coating.

21. A battery housing comprising:
at least one housing wall for enclosing an interior to receive a battery cell arrangement, and
the insulator device of claim 1,
wherein the at least one insulating device is arranged between the battery cell arrangement and the housing wall in the interior.

22. The battery housing according to claim 21, wherein the at least one housing wall is formed from a thermoplastic resin.

23. The battery housing according to claim 21, wherein the battery housing is configured for assembly in an electrically driven motor vehicle.
